(19) United States
(12) Patent Application Publication
(10) Pub. No.: US 2016/0228860 A1
(43) Pub. Date: Aug. 11, 2016

(54) CATALYTIC ACTIVATED CARBON STRUCTURES AND METHODS OF USE AND MANUFACTURE

(71) Applicant: MEADWESTVACO CORPORATION, Richmond, VA (US)

(72) Inventors: Cameron I. Thomson, Charleston, SC (US); Caitlin D. Naske, Summerville, SC (US)

(21) Appl. No.: 15/021,662

(22) PCT Filed: Sep. 12, 2014
(86) PCT No.: PCT/US14/55504

§ 371 Date: Mar. 11, 2016

Related U.S. Application Data
(60) Provisional application No. 61/877,535, filed on Sep. 13, 2013.

(51) Int. Cl. B01J 27/24; B01J 37/04; C02F 1/28; B01J 35/10; B01D 53/86; B01J 37/08; B01J 35/04

(52) U.S. Cl. CPC B01J 27/24; B01J 37/084; B01J 37/04; B01J 35/04; B01J 35/1019; B01J 35/1023; B01J 35/1028; B01D 53/8612; C02F 1/288; C02F 1/281; C02F 1/283; B01D 2255/702; B01D 2255/707; B01D 2255/20761; C02F 2101/101

(57) ABSTRACT

The present disclosure relates generally to catalytic activated carbon structures and the methods of removing sulfur-containing compounds from fluid stream using such catalytic activated carbon structures. In certain aspects, the catalytic activated carbon structure comprise nitrogen-enriched activated carbon, cuprous oxide, and a binder, wherein the nitrogen-enriched activated carbon includes from about 0.5% to about 10% by weight of nitrogen based on total weight of the nitrogen-enriched activated carbon, at least about 30% by weight of the nitrogen are aromatic nitrogen species having a binding energy of at least 398.0 eV as determined by XPS.

### CROSS-REFERENCE TO RELATED APPLICATIONS

This application claims the benefit of priority to U.S. Provisional Patent Application Ser. No. 61/877,535, titled: Catalytic Activated Carbon Honeycombs and Methods of Removing Sulfur-Containing Compounds from Fluid Stream, filed: Sep. 13, 2013, the disclosure of which is incorporated herein by reference in its entirety.

### FIELD OF THE INVENTION

The present disclosure relates generally to catalytic activated carbon structures and the methods of removing sulfur-containing compounds from fluid stream using such catalytic activated carbon structures.

### BACKGROUND

Malodorous sulfur-containing compounds occur in a number of environments such as petroleum storage areas, sewage treatment facilities, wastewater treatment plants, and industrial plants such as petrochemical refining sites, pulp and paper production sites. In these environments, malodorous hydrogen sulfide (H₂S) gas is prevalently responsible for the presence of disagreeable odors, along with other sulfur-containing malodorous compounds such as alkyl sulfide, dimethyl sulfide, dimethyl disulfide and methyl mercaptan.

Activated carbon is known to remove hydrogen sulfide from both gaseous and aqueous phases. However, the reaction rate and the hydrogen sulfide loading on the activated carbon limit the economic viability. For example, fluid stream having sulfur-containing compounds is typically passed through a bed of granular or fibrous activated carbon adsorbent for removal of sulfur-containing compounds. When granular or fibrous activated carbon is used as an adsorbent, the adsorbent bed has high flow resistance and consequently consumes significantly large amount of operation energy. Furthermore, the malodorous sulfur-containing compounds usually present in the gas stream at very low concentrations that it is difficult to effectively remove all of these malodorous sulfur-containing compounds. The poor kinetic rate of H₂S removal and the low H₂S adsorption capacity of activated carbon limit the economic viability of the activated carbon for removal of H₂S in gas stream. A typical coal-based activated carbon has a H₂S adsorption capacity of only 0.01 to 0.02 g/cc, and the efficiency of H₂S removal is often meager. Accordingly, a large quantity of activated carbon is required for the removal of malodorous sulfur-containing compounds.

There has been effort to improve the H₂S adsorption capacity of activated carbon. For example, certain formulations have achieved a H₂S adsorption capacity of about 0.09 to 0.11 g/cc. However, at this level of H₂S adsorption capacity improvement still limits the economic viability of activated carbon for removal of H₂S in the fluid steam containing low amounts of H₂S, such as at less than about 0.1 ppm. In another example, pelletized activated carbon has been impregnated with sodium hydroxide (NaOH) and moisture. The pore structure of the activated carbon is somewhat filled with the caustic NaOH, thereby lowering the adsorption capacity of the impregnated activated carbon. Furthermore, the caustic impregnated activated carbon may be susceptible to uncontrolled thermal excursions, resulting from a suppressed combustion temperature and exothermic reactions caused by the caustic impregnation.

More recent attempts at improving the H₂S adsorption capacity of activated carbon have included impregnating the activated carbon with metal oxides or forming a matrix with metal oxides (e.g., Ca, Mg, Ba or combinations thereof). However, such filters only demonstrate H₂S adsorption capacity of about 0.1 to 0.3 g/cc, and 0.26 g/cc, respectively. The activated carbon-metal oxide matrix is prepared by preoxidizing a carbon material, ling the preoxidized carbon material; mixing the ground preoxidized material with an of Ca, Mg, Ba, or combinations thereof to form a carbon mixture; extruding the carbon mixture into desired structure; carbonizing and activating the extrudate. It is, however, found that such preparation process leaves significant amounts of the active agents unavailable for reaction. The metal oxide impregnated activated carbon media is prepared by forming the activated carbon into a desired structure; impregnating the formed activated carbon media with a solution of Mg salt, Ca salt or both metal salts by spraying the activated carbon structure with the salt solution; and converting the metal salt into a metal oxide. However, pure metal oxides have a limited capacity for H₂S because of their low pore volume and surface area, and the oxidation reaction of H₂S is too slow to have any practical application to odor control. In addition, pure metal oxides do not exhibit significant adsorption capacity for organic compounds that do not react with the substrate. As a result, these metal oxides are not commercially relevant.

Thus, prior activated carbon adsorbents suffer from a number of well-known disadvantages, including: the activated carbon has a low capacity for H₂S, the activated carbon has a slow kinetic rate of H₂S removal; the adsorption capacity is low, relatively high amounts of metal oxide must be dispersed throughout the carbon matrix, and high flow resistance. Accordingly, it is desirable to have activated carbon adsorbent having improved H₂S adsorption capacity, enhanced kinetic rate of H₂S removal, and low flow resistance.

### SUMMARY

Presently described are adsorbent media or materials that have high H₂S adsorption capacity, enhanced kinetic rate of H₂S removal, and low flow resistance. As such, in certain aspects the description provides catalytic activated carbon materials, methods of making and using the same to remove H₂S from fluid stream.

In one aspect, the description provides a catalytic activated carbon material comprising a matrix including nitrogen-enriched activated carbon, cuprous oxide, and a binder. In certain embodiments, the nitrogen-enriched activated carbon includes from about 0.5% to about 10% by weight of nitrogen based on total weight of the nitrogen-enriched activated carbon. In additional embodiments, at least 30%, 40%, 50%, 60%, 70%, 80%, 90% or 100% by weight of the nitrogen in the nitrogen-enriched activated carbon includes aromatic nitrogen species having a binding energy of at least about 398.0 eV as determined using XPS. In additional embodiments, at least 30%, 40%, 50%, 60%, 70%, 80%, 90% or 100% by weight of the nitrogen in the nitrogen-enriched activated carbon includes aromatic nitrogen species having a binding energy of from at least about 398.0 eV to about 403.1 eV as determined using XPS. In certain additional embodiments, at least 30%, 40%, 50%, 60%, 70%, 80%, 90% or 100% by weight of the nitrogen in the nitrogen-enriched activated carbon includes aromatic nitrogen species having a binding energy of from at least about 398.0 eV to about 401.3 eV as determined using XPS.

In another aspect, the description provides a calcined catalytic activated carbon material comprising a matrix including nitrogen-enriched activated carbon, cuprous oxide, and a binder, wherein the matrix material is calcined or heated at a temperature of from about 500° C. to about 1200° C. In certain embodiments, the matrix material is calcined or heated at a temperature of from about 900° C. to about 1100° C. In certain embodiments, the matrix material is calcined or heated at about 1100° C. for from about 1 to about 10 hours. In certain additional embodiments, the material is calcined or heated at about 1100° C. for about 3 hours.

In certain embodiments, the description provides a catalytic activated carbon material as described herein, wherein the catalytic activated carbon material is calcined sufficiently to enhance at least one of: the ASTM H₂S binding capacity, the amount of quaternary aromatic nitrogen species (i.e., aromatic nitrogen having a binding energy of at least 401.3 eV as determined by XPS), the H₂S removal efficiency or a combination thereof. In certain embodiments, the catalytic activated carbon material is calcined at a sufficient temperature and for a sufficient period to effectuate enhanced ASTM H₂S binding capacity, efficiency or both. In certain embodiments, the H₂S removal efficiency is determined at 1 ppm H₂S and with a fluid stream flow rate of from about 100 ft/min to about 500 ft/min. In certain additional embodiments, the catalytic activated carbon material as described herein is calcined at a sufficient temperature and duration to effectuate enhanced removal efficiency of H₂S binding of at least about 80% at 1 ppm H₂S as determined at a fluid stream flow rate of from about 100 ft/min to about 500 ft/min. In certain additional embodiments, the catalytic activated carbon material as described herein is calcined at a temperature of from about 500° C. to about 1200° C., for from about 1 to about 10 hours, wherein the calcined catalytic activated carbon demonstrates enhanced removal efficiency of H₂S binding of at least about 80% at 1 ppm H₂S as determined at a fluid stream flow rate of from about 100 ft/min to about 500 ft/min.

In certain embodiments, the calcination is performed in an inert atmosphere of, e.g., nitrogen (N₂), Argon (Ar), Helium (He), or combinations thereof. In certain embodiments, the nitrogen-enriched activated carbon includes from about 0.5% to about 10% by weight of nitrogen based on total weight of the nitrogen-enriched activated carbon. In additional embodiments, at least 30%, 40%, 50%, 60%, 70%, 80%, 90% or 100% by weight of the nitrogen in the pre-calcined nitrogen-enriched activated carbon includes aromatic nitrogen species having a binding energy of at least about 398.0 eV. In certain additional embodiments, at least 30%, 40%, 50%, 60%, 70%, 80%, 90% or 100% by weight of the nitrogen in the nitrogen-enriched activated carbon includes aromatic nitrogen species having a binding energy of from at least about 398.0 eV to about 403.1 eV as determined using XPS.

In certain additional embodiments, at least 30%, 40%, 50%, 60%, 70%, 80%, 90% or 100% by weight of the nitrogen in the calcined catalytic activated carbon includes aromatic nitrogen species having a binding energy of 401.3 eV (quaternary aromatic nitrogen species) as determined using XPS. In still further embodiments, the amount of aromatic nitrogen species having a binding energy of 401.3 eV as determined using XPS is increased by at least about 30%, 40%, 50%, 60%, 70%, 80%, 90% or 100% as compared to the non-calcined catalytic activated carbon. In still further embodiments, the amount of aromatic nitrogen species having a binding energy of 401.3 eV as determined using XPS is increased by at least about 80%, 90% or 100% as compared to the non-calcined catalytic activated carbon.

In still additional embodiments, the description provides calcined catalytic activated carbon material that demonstrates an increase in H₂S adsorption capacity of at least about 20%, 30%, 40%, 50%, 60%, 70%, 80%, 90% or 100% as determined using ASTM D6646-03 method.

In a preferred embodiment, the catalytic activated carbon material is formed into a structure that reduces or ameliorates fluid stream pressure drop through the material. For example, in certain exemplary embodiments, the structure is a honeycomb or corrugated carbon paper. However, the description is not so limited, any structure that is sufficient to reduce, prevent or ameliorate pressure drop in a fluid stream, which would be known to those of skill in the art, is contemplated. In certain preferred embodiments, the structure is a honeycomb. In still further embodiments, the honeycomb structure has a cell density of from about 10 to about 1500 cells per square inch. It is contemplated that the cells of the honeycomb may have any desired shape or configuration that would be known to those of skill in the art. In certain embodiments, the honeycomb is produced by extrusion of the catalytic activated carbon material.

In any of the aspects or embodiments of the catalytic activated carbon material described herein, the catalytic activated carbon material comprises nitrogen-enriched activated carbon in an amount of from 10% to about 80% by weight based on total weight of the material.

In any of the aspects or embodiments of the catalytic activated carbon material described herein, the catalytic activated carbon material comprises cuprous oxide in an amount of from 5% to about 50% by weight based on total weight of the material. In certain embodiments, the cuprous oxide has a D90 particle size of less than about 40 microns.

In any of the aspects or embodiments described herein, the catalytic activated carbon material has a B.E.T. surface area of from about 200 m²/g to about 3000 m²/g.

In any of the aspects or embodiments described herein, the nitrogen-enriched activated carbon or catalytic activated carbon material may comprise an extrusion aid. By way of non-limiting example, the extrusion aid can comprise an organic extrusion aid such as, e.g., polyethylene glycol and cellulose derivatives such as carboxymethylcellulose, methyl cellulose, methylhydroxypropylcellulose, hydroxyethylcellulose, hydroxypropylcellulose or combinations thereof. In general, it is desirable that the extrusion aids thermally decompose during calcination such that additional surface area is created that facilitates adsorption or reaction with compounds in the fluid stream. Thus, additional suitable extrusion aids, which are known in the art or that become known, are contemplated for use in the compositions and methods described herein.

In another aspect, the description provides a catalytic activated carbon material prepared according to a process comprising: (a) activating a carbon precursor or pyrolyzing an activated carbon while contacting the carbon material with at least ammonia to provide a nitrogen-enriched activated carbon; (b) admixing the nitrogen-enriched activated carbon with cuprous oxide, and a binder; and (c) forming a three-dimensional structure from the admixture of (b). In certain embodiments, the nitrogen-enriched activated carbon, cuprous oxide, and binder are combined to form a matrix prior to forming the three-dimensional structure.

In still another aspect, the description provides a catalytic activated carbon material prepared or formed according to a process comprising: (a) activating a carbon precursor or pyrolyzing an activated carbon while contacting the carbon material with at least ammonia to provide a nitrogen-enriched activated carbon; (b) admixing the nitrogen-enriched activated carbon with cuprous oxide, and a binder; (c) forming a three-dimensional structure from the admixture of (b); and (d) heating the structure from (c) at a temperature of from about 500° C. to about 1200° C. In certain embodiments, the nitrogen-enriched activated carbon, cuprous oxide, and binder are combined to form a matrix prior to forming the three-dimensional structure.

In certain embodiments, at least 30%, 40%, 50%, 60%, 70%, 80%, 90% or 100% by weight of the nitrogen in the calcined catalytic activated carbon includes aromatic nitrogen species having a binding energy of 401.3 eV (quaternary aromatic nitrogen species) as determined using XPS. In still further embodiments, the amount of aromatic nitrogen species having a binding energy of 401.3 eV as determined using XPS is increased by at least about 30%, 40%, 50%, 60%, 70%, 80%, 90% or 100% as compared to the non-calcined catalytic activated carbon. In still further embodiments, the amount of aromatic nitrogen species having a binding energy of 401.3 eV as determined using XPS is increased by at least about 80%, 90% or 100% as compared to the non-calcined catalytic activated carbon.

In still additional embodiments, the description provides calcined catalytic activated carbon material that demonstrates an increase in H₂S adsorption capacity of at least about 20%, 30%, 40%, 50%, 60%, 70%, 80%, 90% or 100% as determined using ASTM D6646-03 method.

In still another aspect, the description provides methods of preparing or forming a catalytic activated carbon material as described herein. In an additional aspect, the description provides methods of preparing or forming a calcined catalytic activated carbon material as described herein.

In an additional aspect, the description provides a method of removing sulfide-containing compounds from a fluid stream (i.e., liquid or air/gas), the method comprising contacting a catalytic activated carbon material according to any of the aspects or embodiments as described herein with a fluid stream. In any of the embodiments as described herein, the catalytic activated carbon material is formed into a honeycomb structure. In certain additional embodiments, the fluid stream is a gas stream, liquid stream or combination thereof comprising a sulfide-containing compound, e.g., hydrogen sulfide.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages objects and embodiments are expressly included within the scope of the present invention. The publications and other materials used herein to illuminate the background of the invention, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIG. 1 is a comparative XPS spectra of the activated carbon No. 3, which is a nitrogen-enriched activated carbon according to one embodiment of the present disclosure, and the activated carbon No. 2 prepared by the process described in U.S. Pat. No. 5,494,869; and

FIG. 2 shows nitrogen species in the nitrogen-enriched activated carbon according to the present disclosure, as identified by the nitrogen peaks at different binding energies of the XPS spectra.

FIG. 3 is a comparison of the effects on nitrogen content (% by weight) of two catalytic activated carbons, AC No.3, an exemplary catalytic activated carbon as described herein), and AC No. 1, a commercially available catalytic activated carbon, after heat treatment (calcination) as determined by examination of N1s peaks from XPS spectra.

FIG. 4 is a comparison of the effects on the pyridine nitrogen fraction of two calcined catalytic activated carbons (AC No. 3 and AC No. 1) after heat treatment as determined by analysis of N1s peaks at 398.3 eV from XPS spectra.

FIG. 5 is a comparison of the effects on the quaternary nitrogen fraction of two catalytic activated carbons (AC No. 3 and AC No. 1) after heat treatment as determined by analysis of N1s peaks at 401.3 eV from XPS spectra.

FIG. 6 is a comparison of the ASTM D6646-03 H₂S binding performance (H₂S adsorption capacity; % by weight) of two catalytic activated carbons (AC No. 3 and AC No. 1) after heat treatment. The measurements were generated from honeycomb structures with nominally 200 cpsi and about 70% void fraction.

FIG. 7 demonstrates the efficiency versus length at 150 ft/min linear air velocity and 1 ppm H₂S of the AC No. 3 catalytic activated carbon after heat treatment.

FIG. 8 demonstrates the efficiency versus length at 500 ft/min linear air velocity and 1 ppm H₂S of the AC No. 3 catalytic activated carbon after heat treatment.

### DETAILED DESCRIPTION

The following is a detailed description provided to aid those skilled in the art in practicing the present invention. Those of ordinary skill in the art may make modifications and variations in the embodiments described herein without departing from the spirit or scope of the present disclosure. All publications, patent applications, patents, figures and other references mentioned herein are expressly incorporated by reference in their entirety.

Presently described are adsorbent media or materials that have surprisingly and unexpectedly high H₂S adsorption capacity, enhanced kinetic rate of H₂S removal, and/or low flow resistance. As such, in certain aspects the description provides catalytic activated carbon materials, methods of making and using the same to remove H₂S from fluid stream (e.g., liquid or air/gas).

The present disclosure now will be described more fully hereinafter, but not all embodiments of the disclosure are shown. While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular structure or material to the teachings of the disclosure without departing from the essential scope thereof. Unless otherwise defined, all technical and scientific terms used herein have the same meaning as commonly understood by one of ordinary skill in the art to which this invention belongs. The terminology used in the description is for describing particular embodiments only and is not intended to be limiting of the invention.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., one or more of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as only one of or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

The term “fluid stream”, as used herein, can mean a gas stream, liquid stream, or combinations thereof.

The term “honeycomb structure”, as used herein, can mean a porous structure defined by a plurality of substantially parallel thin channels extending therethrough. In any of the aspects or embodiments described herein, the cells that comprise the honeycomb structure (e.g., in cross-section) can be of any desired geometrical configuration, e.g., square, hexagonal, circular, etc. Moreover, it is contemplated that the structure can be formed by any number of methods that are well-known, e.g., extrusion.

Carbon is a substance that has a long history of being used to adsorb impurities and is perhaps the most powerful adsorbent known to man. One pound of carbon contains a surface area of roughly 125 acres and can adsorb literally thousands of different chemicals. Activated carbon which has a slight electro-positive charge added to it, making it even more attractive to chemicals and impurities.

Activated carbon, also called activated charcoal, activated coal, or carbo activatus, is a form of carbon processed to have small, low-volume pores that increase the surface area available for adsorption or chemical reactions. Due to its high degree of microporosity, just one gram of activated carbon has a surface area in excess of 500 m², as determined by gas adsorption. An activation level sufficient for useful application may be attained solely from high surface area; however, further chemical treatment often enhances adsorption properties. Activated carbon is usually derived from charcoal and increasingly, high-porosity biochar. Activated carbon is carbon produced from carbonaceous source materials such as nutshells, coconut husk, peat, wood, coir, lignite, coal, and petroleum pitch.

Activated carbon can be produced by one of the following processes:

1. Physical reactivation: The source material is developed into activated carbons using hot gases. This is generally done by using one or a combination of the following processes:
(a) Carbonization: Material with carbon content is pyrolyzed at temperatures, e.g., in the range 600-900° C., in absence of oxygen (usually in inert atmosphere with gases like argon or nitrogen)
(b) Activation/Oxidation: Raw material or carbonized material is exposed to oxidizing atmospheres (oxygen or steam) at temperatures above 250° C., usually in the temperature range of, e.g., 600-1200° C.

2. Chemical activation: Prior to carbonization, the raw material is impregnated with certain chemicals. The chemical is typically an acid, strong base, or a salt (phosphoric acid, potassium hydroxide, sodium hydroxide, calcium chloride, and zinc chloride 25%). Then, the raw material is carbonized at lower temperatures (450-900° C.).

Normally, activated carbons are made in particulate form as powders (PAC) or fine granules (GAC) less than 1.0 mm in size with an average diameter between 0.15 and 0.25 mm. Thus they present a large surface to volume ratio with a small diffusion distance.

PAC material is finer material. PAC is made up of crushed or ground carbon particles, 95-100% of which will pass through a designated mesh sieve. The ASTM classifies particles passing through an 80-mesh sieve (0.177 mm) and smaller as PAC. It is not common to use PAC in a dedicated vessel, due to the high head loss that would occur. Instead, PAC is generally added directly to other process units, such as raw water intakes, rapid mix basins, clarifiers, and gravity filters.

Granular activated carbon has a relatively larger particle size compared to powdered activated carbon and consequently, presents a smaller external surface. Diffusion of the adsorbate is thus an important factor. These carbons are suitable for absorption of gases and vapors, because they diffuse rapidly. Granulated carbons are used for water treatment, deodorization and separation of components of flow system and are also used in rapid mix basins. GAC can be either in granular or extruded form. GAC is designated by sizes such as 8×20, 20×40, or 8×30 for liquid phase applications and 4×6, 4×8 or 4×10 for vapor phase applications. A 20×40 carbon is made of particles that will pass through a U.S. Standard Mesh Size No. 20 sieve (0.84 mm) (generally specified as 85% passing) but be retained on a U.S. Standard Mesh Size No. 40 sieve (0.42 mm) (generally specified as 95% retained). AWWA (1992) B604 uses the 50-mesh sieve (0.297 mm) as the minimum GAC size. The most popular aqueous phase carbons are the 12×40 and 8×30 sizes because they have a good balance of size, surface area, and head loss characteristics.

The two most important factors affecting the efficiency of activated carbon filtration are the amount of carbon in the unit and the amount of time the contaminant spends in contact with it. The more carbon the better. Similarly, the lower the flow rate of the water, the more time contaminants will be in contact with the carbon, and the more adsorption that will take place. Particle size also affects removal rates. While coconut shell carbon typically costs 20% more than the others, it is generally regarded as the most effective of the three.

There are two principal mechanisms by which activated carbon removes contaminants, adsorption, and catalytic reduction, a process involving the attraction of negatively-charged contaminants ions to the positively-charged activated carbon.

Nitrogen-Enriched Activated Carbon

In one aspect, the description provides a catalytic activated carbon material comprising a matrix including nitrogen-enriched activated carbon, cuprous oxide, and a binder. In certain embodiments, the nitrogen-enriched activated carbon includes from about 0.5% to about 10% by weight of nitrogen based on total weight of the nitrogen-enriched activated carbon. In additional embodiments, at least 30%, 40%, 50%, 60%, 70%, 80%, 90% or 100% by weight of the nitrogen in the nitrogen-enriched activated carbon includes aromatic nitrogen species having a binding energy of at least about 398.0 eV as determined using XPS.

In additional embodiments, at least 30%, 40%, 50%, 60%, 70%, 80%, 90% or 100% by weight of the nitrogen in the nitrogen-enriched activated carbon includes aromatic nitrogen species having a binding energy of from at least about 398.0 eV to about 403.1 eV as determined by XPS. In certain additional embodiments, at least 30%, 40%, 50%, 60%, 70%, 80%, 90% or 100% by weight of the nitrogen in the nitrogen-enriched activated carbon includes aromatic nitrogen species having a binding energy of from at least about 398.0 eV to about 401.3 eV as determined by XPS.

In some embodiments, the nitrogen-enriched activated carbon may include from about 0.5% to about 10% by weight of nitrogen based on total weight of the nitrogen-enriched activated carbon, wherein at least about 30% by weight of the nitrogen are aromatic nitrogen species having a binding energy of from about 398.0 eV to about 400.8 eV as determined by XPS.

In some embodiments, the nitrogen-enriched activated carbon may include about 0.5% to about 10% weight of nitrogen based on total weight of the nitrogen-enriched activated carbon, wherein at least about 50% by weight of the nitrogen are aromatic nitrogen species having a binding energy of from about 398.0 eV to about 400.8 eV as determined by XPS.

In some embodiments, the nitrogen-enriched activated carbon may include about 1.0% to about 5% by weight of nitrogen based on total weight of the nitrogen-enriched activated carbon, wherein at least about 30% by weight of the nitrogen are aromatic nitrogen species having a binding energy of from about 398.0 eV to about 400.8 eV as determined by XPS.

In another aspect, the description provides a calcined catalytic activated carbon material comprising a matrix including nitrogen-enriched activated carbon, cuprous oxide, and a binder, wherein the matrix material is calcined or heated at a temperature of from about 500° C. to about 1200° C. In certain embodiments, the matrix material is calcined or heated at a temperature of from about 900° C. to about 1100° C. In certain embodiments, the matrix material is calcined or heated at about 1100° C. for from about 1 to about 10 hours. In certain additional embodiments, the material is calcined or heated at about 1100° C. for about 3 hours.

As an example, the catalytic activated carbon material can be calcined by a heating according to a 6 hr ramp at about 3° C/min to the target temperature followed by a 3 hr hold, e.g., at about 1100° C. The process is typically performed in an inert atmosphere, e.g., N₂. However, other inert gasses may be utilized, including He and Ar. In certain embodiments, calcination at 1100° C. is useful for improved strength as well as to change the carbon properties.

In certain embodiments, the description provides a catalytic activated carbon material as described herein, wherein the catalytic activated carbon material is calcined sufficiently to enhance at least one of: the ASTM H₂S binding capacity, the amount of quaternary aromatic nitrogen species (i.e., aromatic nitrogen having a binding energy of at least 401.3 eV as determined by XPS), the H₂S removal efficiency or a combination thereof. In certain embodiments, the catalytic activated carbon material is calcined at a sufficient temperature and for a sufficient period to effectuate enhanced ASTM H₂S binding capacity, H₂S removal efficiency or both. In certain embodiments, the H₂S removal efficiency is determined at 1 ppm H₂S and with a fluid stream flow rate of from about 100 ft/min to about 500 ft/min. In certain additional embodiments, the catalytic activated carbon material as described herein is calcined at a sufficient temperature and duration to effectuate enhanced efficiency of H₂S binding of at least about 80% at 1 ppm H₂S as determined at a fluid stream flow rate of from about 100 ft/min to about 500 ft/min. In certain additional embodiments, the catalytic activated carbon material as described herein is calcined at a temperature of from about 500° C. to about 1200° C., for from about 1 to about 10 hours, wherein the calcined catalytic activated carbon demonstrates enhanced efficiency of H₂S binding of at least about 80% at 1 ppm H₂S as determined at a fluid stream flow rate of from about 100 ft/min to about 500 ft/min.

In certain embodiments, the calcination is performed in an inert atmosphere of, e.g., nitrogen (N₂), Argon (Ar), Helium (He), or combinations thereof. In certain embodiments, the nitrogen-enriched activated carbon includes from about 0.5% to about 10% by weight of nitrogen based on total weight of the nitrogen-enriched activated carbon. In additional embodiments, at least 30%, 40%, 50%, 60%, 70%, 80%, 90% or 100% by weight of the nitrogen in the pre-calcined nitrogen-enriched activated carbon includes aromatic nitrogen species having a binding energy of at least about 398.0 eV. In certain additional embodiments, at least 30%, 40%, 50%, 60%, 70%, 80%, 90% or 100% by weight of the nitrogen in the pre-calcined nitrogen-enriched activated carbon includes aromatic nitrogen species having a binding energy of from at least about 398.0 eV to about 403.1 eV as determined by XPS.

In certain additional embodiments, at least 30%, 40%, 50%, 60%, 70%, 80%, 90% or 100% by weight of the nitrogen in the calcined catalytic activated carbon includes aromatic nitrogen species having a binding energy of 401.3 eV (quaternary aromatic nitrogen species) as determined by XPS. In still further embodiments, the amount of aromatic nitrogen species having a binding energy of 401.3 eV as determined by XPS is increased by at least about 30%, 40%, 50%, 60%, 70%, 80%, 90% or 100% as compared to the non-calcined catalytic activated carbon. In still further embodiments, the amount of aromatic nitrogen species having a binding energy of 401.3 eV as determined using XPS is increased by at least about 80%, 90% or 100% as compared to the non-calcined catalytic activated carbon.

In still additional embodiments, the description provides calcined catalytic activated carbon material that demonstrates an increase in H₂S adsorption capacity of at least about 20%, 30%, 40%, 50%, 60%, 70%, 80%, 90% or 100% as determined using ASTM D6646-03 method.

In any of the aspects or embodiments of the catalytic activated carbon material as described herein, the catalytic activated carbon material may be configured or formed into a three-dimensional structure, e.g., a monolith, corrugated carbon paper, a foam, fibers such as a mesh or woven, pellets, granules, powder or honeycomb. In certain embodiments the structures are incorporated into a container or series of containers. In additional embodiments, one or more structures, including structures of different types can be assembled or coupled in series or in parallel. In any of the aspects or embodiments of the catalytic activated carbon material described herein (including calcined catalytic activated carbon material), the catalytic activated carbon material comprises nitrogen-enriched activated carbon in an amount of at least about 5% by weight, and preferably from 10% to about 80% by weight based on total weight of the material.

In any of the aspects or embodiments described herein (including calcined catalytic activated carbon material), the catalytic activated carbon material comprises cuprous oxide in an amount of from 5% to about 50% by weight based on total weight of the catalytic activated carbon material. In certain embodiments, the cuprous oxide has a D90 particle size of less than about 40 microns.

In any of the aspects or embodiments described herein, the activated carbon is formed from activated carbon or an activated carbon precursor (i.e., a feed material useful for preparing or forming activated carbon). In certain embodiments, the activated carbon precursor comprises a member selected from the group consisting of wood, wood dust, wood flour, cotton linters, peat, coal, lignite, petroleum pitch, petroleum coke, coal tar pitch, carbohydrates, coconut, fruit pits, fruit stones, nut shells, nut pits, sawdust, palm, vegetables, synthetic polymer, natural polymer, lignocellulosic material, and combinations thereof.

In any of the aspects or embodiments described herein, the binder comprises, for example, a member selected from the group consisting of ceramic, clay, cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof. Additional binders are known to those of skill in the art and are contemplated for use in any of the embodiments described herein.

In any of the aspects or embodiments described herein, the catalytic activated carbon material has a B.E.T. surface area of from about 200 m²/g to about 3000 m²/g. In some embodiments, the catalytic activated carbon honeycomb material may have a B.E.T. surface area of about 1000 m²/g to about 2000 m²/g. In some embodiments, the catalytic activated carbon honeycomb material may have a B.E.T. surface area of from about 200 m²/g to about 1000 m²/g.

In some embodiments, the nitrogen-enriched activated carbon may be obtained from the carbon precursors that have been contacted or otherwise exposed to nitrogen-containing compounds at a temperature of at least about 700° C.

In some embodiments, the nitrogen-enriched activated carbon may be obtained by pyrolyzing carbon precursor while simultaneously passing a gas stream comprised of NH₃ and an oxygen-containing gas through the carbon precursor. By way of non-limiting examples, the gas stream comprised of NH₃ and an oxygen-containing gas may include NH₃/CO₂ gas stream, NH₃/O₂ gas stream, NH₃/H₂O gas stream, or NH₃/NOₓ gas stream. In some embodiments, the gas stream comprised of NH₃ and an oxygen-containing gas may comprise up to 10 parts of NH₃ per 90 parts of oxygen-containing gas. The carbon precursor may be pyrolyzed at a temperature of at least about 700° C.

In some embodiments, the nitrogen-enriched activated carbon may be obtained by the process described in U.S. Pat. No. 4,624,937 by Chou, issued on Nov. 25, 1986. The process may include pyrolyzing carbon precursor at a temperature of from about 800° C. to about 1200° C. while simultaneously passing a gas stream comprised of an oxygen-containing gas and NH₃ gas in a ratio of up to 90:10 through the carbon precursor for a time sufficient to remove surface oxides from the carbon precursor. Non-limiting examples of the gas stream comprised of an oxygen-containing gas and NH₃ gas may include a NH₃/CO₂ gas stream, a NH₃/O₂ gas stream, a NH₃/H₂O gas stream, or a NH₃/NOₓ gas stream.

In some embodiments, the nitrogen-enriched activated carbon may be obtained by pyrolyzing carbon precursors in presence of ammonia at temperatures of at least about 700° C., such as about 780° C. to 960° C., with or without simultaneous exposure to an oxygen-containing vapor or gas.

Catalytic Activated Carbon Structures

In a preferred embodiment, the catalytic activated carbon material is formed into a structure that reduces or ameliorates fluid stream pressure drop through the material. For example, in certain exemplary embodiments, the structure is a honeycomb or corrugated carbon paper. However, the description is not so limited, any structure that is sufficient to reduce, prevent or ameliorate pressure drop in a fluid stream, which would be known to those of skill in the art, is contemplated. In certain preferred embodiments, the structure is a honeycomb. In still further embodiments, the honeycomb structure has a cell density of from about 10 to about 1500 cells per square inch. It is contemplated that the cells of the honeycomb may have any desired shape or configuration that would be known to those of skill in the art. In certain embodiments, the honeycomb is produced by extrusion of the catalytic activated carbon material.

Extruded activated carbon combines powdered activated carbon with a binder, which are fused together and extruded into a cylindrical shaped activated carbon block with diameters, e.g., from about 0.5 to 150 mm. In certain embodiments, the nitrogen-enhanced or catalytic activated carbon as described herein is formed into a honeycomb structure. These structures are particularly advantageous for use with fluid stream applications because of their low pressure drop, high mechanical strength and low dust content.

In any of the aspects or embodiments described herein, the nitrogen-enriched activated carbon or catalytic activated carbon material may comprise an extrusion aid. By way of non-limiting example, the extrusion aid can comprise an organic extrusion aid such as, e.g., polyethylene glycol and cellulose derivatives such as carboxymethylcellulose, methyl cellulose, methylhydroxypropylcellulose, hydroxyethylcellulose, hydroxypropylcellulose or combinations thereof. In general, it is desirable that the extrusion aids thermally decompose during calcination such that additional surface area is created that facilitates adsorption or reaction with compounds in the fluid stream. Thus, additional suitable extrusion aids, which are known in the art or that become known, are contemplated for use in the compositions and methods described herein.

In another aspect, the description provides a catalytic activated carbon material prepared according to a process comprising: (a) activating a carbon precursor or pyrolyzing an activated carbon while contacting the carbon material with at least ammonia to provide a nitrogen-enriched activated carbon; (b) admixing the nitrogen-enriched activated carbon with cuprous oxide, and a binder; and (c) forming a three-dimensional structure from the admixture of (b). In certain embodiments, the nitrogen-enriched activated carbon, cuprous oxide, and binder are combined to form a matrix prior to forming the three-dimensional structure.

In still another aspect, the description provides a catalytic activated carbon material prepared or formed according to a process comprising: (a) activating a carbon precursor or pyrolyzing an activated carbon while contacting the carbon material with at least ammonia to provide a nitrogen-enriched activated carbon; (b) admixing the nitrogen-enriched activated carbon with cuprous oxide, and a binder; (c) forming a three-dimensional structure from the admixture of (b); and (d) heating the structure from (c) at a temperature of from about 500° C. to about 1200° C. In certain embodiments, the nitrogen-enriched activated carbon, cuprous oxide, and binder are combined to form a matrix prior to forming the three-dimensional structure.

In certain embodiments, the material from (b) is formed into a honeycomb structure and calcined or heated at between about 500° C. and about 1200° C., preferably between 900° C. and about 1100° C. In certain additional embodiments, the material from (b) is calcined or heated at about 1100° C. for from about 1 to about 10 hours. In a preferred embodiment, the material is calcined or heated at 1100° C. for about 3 hours.

In certain embodiments, the calcination is performed in an inert atmosphere of, e.g., nitrogen (N₂), Argon (Ar), Helium (He), or combinations thereof. In further embodiments, the nitrogen-enriched activated carbon includes from about 0.5% to about 10% weight of nitrogen based on total weight of the nitrogen-enriched activated carbon. In additional embodiments, at least 30%, 40%, 50%, 60%, 70%, 80%, 90% or 100% by weight of the nitrogen in the pre-calcined nitrogen-enriched activated carbon includes aromatic nitrogen species having a binding energy of at least about 398.0 eV as determined by XPS. In certain additional embodiments, at least 30%, 40%, 50%, 60%, 70%, 80%, 90% or 100% by weight of the nitrogen in the pre-calcined nitrogen-enriched activated carbon includes aromatic nitrogen species have a binding energy of from at least about 398.0 eV to about 403.1 eV as determined by XPS.

In certain additional embodiments of the methods described herein, at least 30%, 40%, 50%, 60%, 70%, 80%, 90% or 100% by weight of the nitrogen in the calcined catalytic activated carbon are aromatic nitrogen species having a binding energy of 401.3 eV (quaternary aromatic nitrogen species) as determined by XPS. In still further embodiments, the amount of aromatic nitrogen species having a binding energy of 401.3 eV as determined using XPS is increased by at least about 30%, 40%, 50%, 60%, 70%, 80%, 90% or 100% as compared to the non-calcined catalytic activated carbon. In still further embodiments, the amount of aromatic nitrogen species having a binding energy of 401.3 eV as determined by XPS is increased by at least about 80%, 90% or 100% as compared to the non-calcined catalytic activated carbon.

In still additional embodiments, the calcined catalytic activated carbon material demonstrates an increase in H₂S adsorption capacity of at least about 20%, 30%, 40%, 50%, 60%, 70%, 80%, 90% or 100% as determined using ASTM D6646-03 method.

In certain embodiments, the catalytic activated carbon material is calcined sufficiently (i.e., at a sufficient temperature and for a sufficient period) to effectuate enhanced ASTM H₂S binding capacity and/or efficiency. In certain embodiments, the efficiency is determined at 1 ppm H₂S and with a fluid stream flow rate of from about 100 ft/min to about 500 ft/min. In certain additional embodiments, the catalytic activated carbon material is calcined sufficiently to effectuate enhanced efficiency of H₂S binding of at least about 80% at 1 ppm H₂S as determined at a fluid stream flow rate of from about 100 ft/min to about 500 ft/min. In certain additional embodiments, the catalytic activated carbon material is calcined at a temperature of from about 500 C to about 1200 C, for from about 1 to about 10 hours, wherein the calcined catalytic activated carbon demonstrates enhanced ASTM efficiency of H₂S binding of at least about 80% at 1 ppm H₂S as determined at a fluid stream flow rate of from about 100 ft/min to about 500 ft/min.

The organization of adsorbent into a honeycomb structure provides several advantages to high flow air treatment systems. The primary benefit is that the pressure drop for honeycomb systems is much less than that of pellet beds. For example, at a linear face velocity of 100 ft/min a typical pellet bed comprised of 4 mm diameter pellets will have a pressure drop of at least 3 in H₂O/ft of bed depth. For comparison a nominal 200 cpsi honeycomb with 70% void space will have roughly 0.3 in H₂O at 100 ft/min. Furthermore at 500 ft/min linear velocity, the pressure drop is just 2 in H₂O/ft honeycomb. This allows you to treat more air with a significantly smaller bed volume.

Thus, in certain embodiments, the description provides a catalytic activated carbon material as described herein sufficient to allow from about 100 to about 500 ft/min linear velocity of flow with a pressure drop of only about 0.3 to 2 in H₂O/ft.

However, in order to take advantage of the improved flow due to the physical structure, the adsorption kinetics of the material must be rapid as the retention time of the gas in the media is very short. A significant contributor to the improved mass transfer kinetics is the very thin cell walls of the honeycomb.

In one particular embodiment, the catalytic activated carbon honeycomb may include nitrogen-enriched activated carbon and cuprous oxide, the nitrogen-enriched activated carbon comprising from about 0.5% to about 10% by weight of nitrogen based on total weight of the nitrogen-enriched activated carbon, wherein at least about 30% by weight of the nitrogen are aromatic nitrogen species having a binding energy of from about 398.0 eV to about 400.8 eV as determined by XPS.

In some embodiments, the catalytic activated carbon honeycomb may include nitrogen-enriched activated carbon and cuprous oxide, the nitrogen-enriched activated carbon comprising from about 0.5% to about 10% by weight of nitrogen based on total weight of the nitrogen-enriched activated carbon, wherein at least about 50% by weight of the nitrogen are aromatic nitrogen species having a binding energy of from about 398.0 eV to about 400.8 eV as determined by XPS.

In some embodiments, the catalytic activated carbon honeycomb may include nitrogen-enriched activated carbon and cuprous oxide, the nitrogen-enriched activated carbon comprising about 1.0% to about 5% by weight of nitrogen based on total weight of the nitrogen-enriched activated carbon, wherein at least about 30% by weight of the nitrogen are aromatic nitrogen species having a binding energy of from about 398.0 eV to about 400.8 eV as determined by XPS.

The catalytic activated carbon honeycomb material may include the nitrogen-enriched activated carbon in an amount of from about 10% to about 80% weight based on total weight of the honeycomb material. In some embodiments, the catalytic activated carbon honeycomb material may include the nitrogen-enriched activated carbon in an amount from about 15% to about 65% weight. In some embodiments, the catalytic activated carbon honeycomb material may include the nitrogen-enriched activated carbon in an amount from about 15% to about 50% weight.

The catalytic activated carbon honeycomb material may include cuprous oxide in an amount from about 5% to about 50% weight based on total weight of the honeycomb material. In some embodiments, the catalytic activated carbon honeycomb material may include cuprous oxide in an amount from about 5% to about 40% weight. In some embodiments, the catalytic activated carbon honeycomb material may include cuprous oxide in an amount from about 10% to about 30% weight.

The catalytic activated carbon honeycomb material may include cuprous oxide having a D90 particle size of less than 40 microns. In some embodiments, the cuprous oxide in may have a D90 particle size of less than 5 microns.

A cross-section of the catalytic activated carbon honeycomb structure taken perpendicular to the direction of extension of the channels reveals the cell density (i.e., number of channels per square inch) of the honeycomb structure. The catalytic activated carbon honeycomb may have a cell density of from about 10 to about 1500 cells per square inch. In some embodiments, the catalytic activated carbon honeycomb may have a cell density of from about 50 to about 500 channels per square inch. In some embodiments, the catalytic activated carbon honeycomb may have a cell density of from about 100 to about 300 cells per square inch.

The catalytic activated carbon honeycomb material may have a B.E.T. surface area of from about 200 m²/g to about 3000 m²/g. In some embodiments, the catalytic activated carbon honeycomb material may have a B.E.T. surface area of about 1000 m²/g to about 2000 m²/g. In some embodiments, the catalytic activated carbon honeycomb material may have a B.E.T. surface area of from about 200 m²/g to about 1000 m²/g.

The catalytic activated carbon honeycomb material may be in any geometrical shape including, but are not limited to, round, cylindrical, or square. Furthermore, the cells of honeycomb adsorbents may be of any geometry.

The catalytic activated carbon honeycomb may be produced by various processes. In one embodiment, the catalytic activated carbon honeycomb may be produced by mixing the nitrogen-enriched activated carbon with cuprous oxide, binder and optionally any desirable additive, and then forming the mixture into honeycomb structure.

Various binders suitable for the formation of honeycomb structure may be used. Non-limiting examples of such binders may include, ceramic material such as clay and cordierite; flux; glass ceramic; metal; mullite; corrugated paper; organic fibers; resin hinder, talc; alumina powder; magnesia powder; silica powder; kaolin powder; sinterable inorganic powder; fusible glass powder; or combinations thereof.

In one embodiment, the catalytic activated carbon honeycomb may be produced by forming a mixture of nitrogen-enriched activated carbon, binder and optionally any desirable additive into honeycomb structure, and then impregnating the honeycomb structure with cuprous oxide Impregnation of cuprous oxide may be achieved by pouring a cuprous salt solution over the activated carbon honeycomb structure, dipping the activated carbon honeycomb structure into a cuprous salt solution, or spraying/blowing the activated carbon honeycomb structure with a cuprous salt solution; and then converting the impregnated cuprous salt into cuprous oxide.

When desired, the catalytic activated carbon honeycomb may be subjected to calcination. Without being limited to any theory, it is believed that the calcination enhances the strength of the catalytic activated carbon honeycomb, and/or modifies the amount of favorable aromatic species. High temperature treatment in an inert atmosphere can change the overall % nitrogen by weight as well as the distribution of nitrogen containing functional groups as measured by XPS.

In one particular embodiment, high temperature treatment or calcination of a catalytic activated carbon honeycomb material that comprises nitrogen-enriched activated carbon and cuprous oxide in an inert atmosphere at 1100° C. reduced overall % nitrogen but increased the proportion of aromatic nitrogen species having a binding energy of about 401.3 eV from 13.3% to 39.5% as determined by XPS.

In still another aspect, the description provides methods of preparing or forming a catalytic activated carbon material comprising: (a) activating a carbon precursor or pyrolyzing an activated carbon in the presence of a nitrogen-containing compound to provide a nitrogen-enriched activated carbon, wherein the nitrogen-enriched activated carbon includes from about 0.5% to about 10% by weight of nitrogen based on total weight of the nitrogen-enriched activated carbon, wherein at least about 30% by weight of the nitrogen is aromatic nitrogen species having a binding energy of at least about 398.0 eV as determined by XPS; (b) admixing the nitrogen-enriched activated carbon with cuprous oxide and a binder; and (c) forming a three-dimensional structure from the admixture of (b). In certain embodiments, the method of preparing a catalytic activated carbon material includes a step of activating, e.g., by pyrolysis, the carbon precursor prior to contacting or exposing the activated carbon to the nitrogen-containing compound. In certain embodiments, the three-dimensional structure is a honeycomb structure.

In an additional aspect, the description provides methods of preparing or forming a calcined catalytic activated carbon material comprising: (a) activating a carbon precursor or pyrolyzing an activated carbon in the presence of a nitrogen-containing compound to provide a nitrogen-enriched activated carbon, wherein the nitrogen-enriched activated carbon includes from about 0.5% to about 10% by weight of nitrogen based on total weight of the nitrogen-enriched activated carbon, wherein at least about 30% by weight of the nitrogen is aromatic nitrogen species having a binding energy of at least about 398.0 eV as determined by XPS; (b) admixing the nitrogen-enriched activated carbon with cuprous oxide and a binder; (c) forming a three-dimensional structure from the admixture of (b); and (d) heating the structure from (c) at a temperature of from about 500° C. to about 1200° C.

While certain exemplary embodiments of the calcined catalytic activated carbon material compositions and methods described herein comprise heating or calcination of the catalytic activated carbon material after the material has been formed into a three-dimensional structure, the description is not so limited. However, additional embodiments of the compositions and methods are contemplated. For example, in an alternative embodiment, the calcined catalytic activated carbon material is prepared or formed by admixing the nitrogen-enriched activated carbon and cuprous oxide; heating or calcining the admixture; admixing the calcined carbon material with binder and/or other additives (e.g., an extrusion aid); and then forming a three-dimensional structure from the complete admixture. In an additional embodiment, the calcined catalytic activated carbon material is prepared or formed by calcining the nitrogen-enriched activated carbon material; admixing the calcined activated carbon material with cuprous oxide, binder, and/or other additive (e.g., an extrusion aid); heating or calcining the admixture; and then forming a three-dimensional structure from the complete admixture.

In certain embodiments, the three-dimensional structure is a honeycomb structure.

In certain embodiments, the nitrogen-enriched activated carbon includes from about 0.5% to about 10% weight of nitrogen based on total weight of the nitrogen-enriched activated carbon. In additional embodiments, at least 30%, 40%, 50%, 60%, 70%, 80%, 90% or 99% by weight of the pre-calcined nitrogen in the nitrogen-enriched activated carbon includes aromatic nitrogen species having a binding energy of at least about 398.0 eV as determined by XPS. In certain additional embodiments, at least 30%, 40%, 50%, 60%, 70%, 80%, 90% or 100% by weight of the pre-calcined nitrogen in the nitrogen-enriched activated carbon includes aromatic nitrogen species have a binding energy of from at least about 398.0 eV to about 403.1 eV as determined by XPS.

In certain additional embodiments, at least 30%, 40%, 50%, 60%, 70%, 80%, 90% or 100% by weight of the nitrogen in the calcined catalytic activated carbon includes aromatic nitrogen species having a binding energy of 401.3 eV (quaternary aromatic nitrogen species) as determined by XPS. In still further embodiments, the amount of aromatic nitrogen species having a binding energy of 401.3 eV as determined by XPS is increased by at least about 30%, 40%, 50%, 60%, 70%, 80%, 90% or 100% as compared to the non-calcined catalytic activated carbon. In still further embodiments, the amount of aromatic nitrogen species having a binding energy of 401.3 eV as determined by XPS is increased by at least about 80%, 90% or 100% as compared to the non-calcined catalytic activated carbon.

In still additional embodiments, the calcined catalytic activated carbon material demonstrates an increase in H₂S adsorption capacity of at least about 20%, 30%, 40%, 50%, 60%, 70%, 80%, 90% or 100% as determined using ASTM D6646-03 method.

In certain embodiments, the nitrogen-enriched activated carbon, cuprous oxide, and binder are combined to form a matrix prior to forming into the honeycomb structure. In certain additional embodiments, the honeycomb structure is formed by extruding the matrix material.

In some embodiments, the material from (b) is formed into a honeycomb structure and calcined or heated at from about 900° C. to about 1100° C. In certain embodiments, the material from (b) is calcined or heated at about 1100° C. for from about 1 to about 10 hours. In a preferred embodiment, the material is calcined or heated at 1100° C. for about 3 hours. In certain embodiments, the calcination is performed in an inert atmosphere of, e.g., nitrogen (N₂), Argon (Ar), Helium (He), or combinations thereof.

In certain embodiments, the methods include a step of calcination of the catalytic activated carbon material sufficient (i.e., at a sufficient temperature and for a sufficient period) to effectuate enhanced H2S binding efficiency. In certain embodiments, the efficiency is determined at 1 ppm H2S and with a fluid stream flow rate of from about 100 ft/min to about 500 ft/min. In certain additional embodiments, the methods include a step of calcination of the catalytic activated carbon material sufficient to effectuate enhanced efficiency of H₂S binding of at least about 80% at 1 ppm H₂S as determined at a fluid stream flow rate of from about 100 ft/min to about 500 ft/min. In certain additional embodiments, the catalytic activated carbon material is calcined at a temperature of from about 500° C. to about 1200° C., for from about 1 to about 10 hours, wherein the calcined catalytic activated carbon demonstrates enhanced efficiency of H₂S binding of at least about 80% at 1 ppm H₂S as determined at a fluid stream flow rate of from about 100 ft/min to about 500 ft/min. In certain embodiments of the methods as described herein, the activated carbon or activated carbon precursor is pyrolyzed at a temperature of at least about 700° C. in the presence of the nitrogen-containing compound to provide a nitrogen-enriched activated carbon.

In any of the aspects or embodiments described herein, the nitrogen-containing compound is ammonia, urea, an amine or a combination thereof. In a preferred embodiment, the nitrogen containing compound used to prepare the nitrogen-enriched activated carbon material is ammonia.

In any of the aspects or embodiments of the methods described herein, the step of preparing or forming a catalytic activated carbon may include contacting the activated carbon or activated carbon precursor with a gas stream comprising ammonia and an oxygen-containing gas.

In still additional embodiments of the methods as described herein, the step of activating a carbon precursor includes pyrolyzing the carbon precursor at a temperature of from about 500° C. to about 1200° C. while contacting the carbon with a gas stream of an oxygen-containing gas and ammonia gas at a ratio of up to 90:10 for a period sufficient to remove surface oxides from the carbon precursor. In certain additional embodiments of the methods as described herein, the step of activating a carbon precursor includes pyrolyzing the carbon precursor at a temperature of above 700° C. while contacting the carbon with a gas stream comprising ammonia through or over the carbon precursor.

Removal of H₂S and Other Sulfur-Containing Compounds From Fluid Steam

In an additional aspect, the description provides a method of removing sulfide-containing compounds from a fluid stream (i.e., liquid or air/gas), the method comprising contacting a catalytic activated carbon material according to any of the aspects or embodiments as described herein with a fluid stream. In any of the embodiments as described herein, the catalytic activated carbon material is formed into a honeycomb structure. In certain additional embodiments, the fluid stream is a gas stream, liquid stream or combination thereof comprising a sulfide-containing compound, e.g., hydrogen sulfide.

In one particular embodiment, the method of removing sulfur-containing compound from a fluid stream may include contacting the fluid stream with a catalytic activated carbon honeycomb material that comprises nitrogen-enriched activated carbon and cuprous oxide, the nitrogen-enriched activated carbon comprising from about 0.5% to about 10% by weight of nitrogen based on total weight of the nitrogen-enriched activated carbon, wherein at least about 30% by weight of the nitrogen are aromatic nitrogen species having a binding energy of from about 398.0 eV to about 403.1 eV as determined by XPS.

In some embodiments, the method of removing sulfur-containing compound from a fluid stream may include contacting the fluid stream with a catalytic activated carbon honeycomb structure that comprises nitrogen-enriched activated carbon and cuprous oxide, the nitrogen-enriched activated carbon comprising from about 0.5% to about 10% by weight of nitrogen based on total weight of the nitrogen-enriched activated carbon, wherein at least about 50% by weight of the nitrogen are aromatic nitrogen species having a binding energy of from about 398.0 eV to about 403.1 eV as determined by XPS.

In some embodiments, the method of removing sulfur-containing compound from a fluid stream may include contacting the fluid stream with a catalytic activated carbon honeycomb structure that comprises nitrogen-enriched activated carbon and cuprous oxide, the nitrogen-enriched activated carbon comprising from about 1% to about 10% by weight of nitrogen based on total weight of the nitrogen-enriched activated carbon, wherein at least about 30% by weight of the nitrogen are aromatic nitrogen species having a binding energy of from about 398.0 eV to about 403.1 eV.

The catalytic activated carbon honeycomb material may be used to remove hydrogen sulfide (H₂S), sulfur dioxide (SO₂) or other sulfur-containing gases from air stream to prevent corrosion and reduce odor.

The catalytic activated carbon honeycomb material may be used to remove hydrogen sulfide (H₂S), sulfur dioxide (SO₂) or other sulfur-containing gases from fluid stream.

The catalytic activated carbon honeycomb material may provide an enhanced adsorption capacity for sulfur-containing compound in the treated fluid stream, yet with a reduced pressure drop (i.e., low flow resistance).

The catalytic activated carbon honeycomb material may be used as adsorption media in various applications. Non-limiting examples of such applications may include industrial corrosion protection, odor removal in wastewater treatment, or odor removal in heating, ventilation and air conditioning (HVAC) system.

### EXAMPLES

All data in the figures and tables was produced with catalytic activated carbon (with or without calcination) honeycombs with nominally 200 cpsi and about 70% void fraction.

Activated Carbon No.1: Activated Carbon No. 1 is the activated carbon disclosed in U.S. Pat. No. 5,494,869 by Hayden and Butterworth, issued on Aug. 16, 1994.

Activated Carbon No. 2

Activated carbon No. 2 was the chemically activated carbon from wood-based precursor that was subjected to a thermal post-treatment.

Activated Carbon No. 3

Activated carbon No. 3 was the nitrogen-enriched activated carbon according to one embodiment of present disclosure. It contained about 0.5% to about 10% by weight of nitrogen based on total weight of the nitrogen-enriched activated carbon, and at least about 30% by weight of the nitrogen are aromatic nitrogen species having a binding energy of from about 398.0 eV to about 400.8 eV, as determined by XPS technique.

X-ray Induced Photoelectron Spectroscopy (XPS) of the Activated Carbon

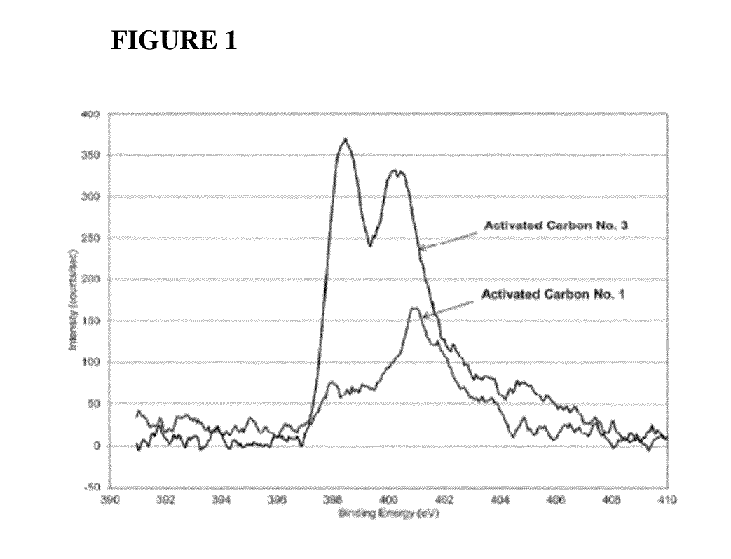

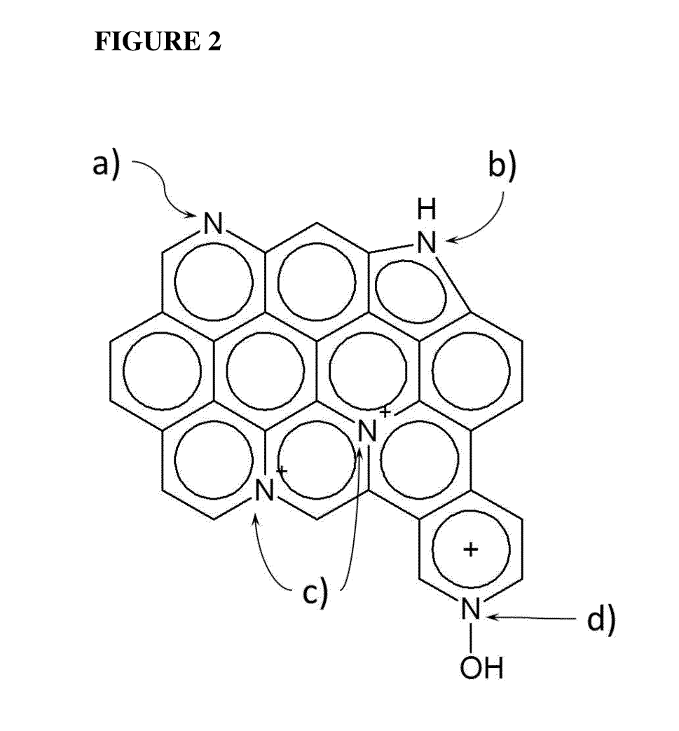

FIG. 1 shows an x-ray induced photoelectron spectroscopy (XPS) of the nitrogen-enriched activated carbon accordingly to one embodiment of the present disclosure (i.e., Activated Carbon (AC) No. 3). FIG. 2 illustrates the nitrogen species present in the nitrogen-enriched activated carbon, as identified by the nitrogen peaks at different binding energies of the XPS spectra.

Each activated carbon sample (activated carbon No. 1, activated carbon No. 2, and activated carbon No. 3) was bombarded with X-ray radiation, causing photoelectrons to be emitted from a core atomic level of the sample and various nitrogen peaks were observed on the XPS spectra. The nitrogen peaks at different binding energies were used to identify the nitrogen species emitting photoelectrons at such binding energies.

XPS data was analyzed using XPSPEAK 4.1 software, including an automatic Shirley background calculation. For example, four peaks are used to fit the N is curve with fixed positions at 398.3 eV (“a”), 400.1 eV (“b”), 401.3 eV (“c”) and 403.1 eV (“d”) binding energies. The peak shapes were fixed at 80% Lorenzian, 20% Gaussian. The software optimizes the fit to the spectra by adjusting the peak area and FWHM (full width at half max) of the four different peaks.

FIG. 1 shows the XPS spectra of the activated carbon No. 3 (an exemplary catalytic activated carbon as described herein) in comparison to the activated carbon No. 1 (a commercially available nitrogen-enriched activated carbon). FIG. 2 shows the nitrogen species in the nitrogen-enriched activated carbon samples as identified by the nitrogen peaks at different binding energies of the XPS spectra. The peaks for nitrogen electrons at binding energies of 398.3 (“a”), 400.1 (“b”), 401.3 (“c”) and 403.1 (“d”) electron volts (eV) are known to associate with pyridine (a), aromatic (pyrrolic) (b), aromatic (quaternary) (c), and N-oxide (e) nitrogen species shown in FIG. 2, respectively.

The activated carbon No. 1 showed a nitrogen peak with the highest intensity at a binding energy of about 401.3 (FIG. 1), which corresponds to the nitrogen aromatic (c) species shown in FIG. 2. The activated carbon No. 3 showed the nitrogen peaks with high intensities at the binding energies (FIG. 1), which correspond to the nitrogen pyridine (a) and the aromatic (b) species shown in FIG. 2, respectively. The activated carbon No. 2 contained no nitrogen on the surface. The activated carbon No. 1 contained some nitrogen species on the surface, but the relative amount and type of the nitrogen species on the activated carbon sample No. 1 were different from those of the activated carbon No. 3, as characterized by the relative intensity and location of the nitrogen peaks in the XPS spectra of FIG. 1.

The activated carbon No. 1, activated carbon No. 2, and activated carbon No. 3 were characterized by the XPS spectroscopy many times. The average nitrogen content and amount of the nitrogen species for each sample were summarized in TABLE 1 based on the intensity and location of the nitrogen peaks in the XPS spectra.

TABLE 1

| | | Amount of Nitrogen Species in the | | | | Relative Percentages of | | | |
|---|---|---|---|---|---|---|---|---|---|
| | | Activated Carbon (% wt) | | | | Nitrogen Species (%) | | | |
| | Nitrogen | | Aromatic | Aromatic | | | Aromatic | Aromatic | |
| Activated | Content | Pyridine | (pyrrolic) | (quaternary) | N—OH | Pyridine | (pyrrolic) | quaternary) | N—OH |
| Carbon | (% wt) | (a) | (b) | (c) | (d) | (a) | (b) | (c) | (d) |
| No. 1 | 1.25 | 0.24 | 0.23 | 0.40 | 0.30 | 19% | 19% | 32% | 30% |
| No. 1 | 1.14 | 0.16 | 0.20 | 0.45 | 0.32 | 14% | 18% | 39% | 28% |
| treated at | | | | | | | | | |
| 1100° C. | | | | | | | | | |
| No. 2 | 0.83 | None | None | None | None | N/A | N/A | N/A | N/A |
| No. 3 | 2.11 | 0.82 | 0.71 | 0.28 | 0.30 | 39% | 34% | 13% | 14% |
| (Present | | | | | | | | | |
| Disclosure) | | | | | | | | | |
| No. 3 | 1.35 | 0.18 | 0.27 | 0.53 | 0.37 | 13% | 20% | 39% | 28% |
| treated at | | | | | | | | | |
| 1100° C. | | | | | | | | | |

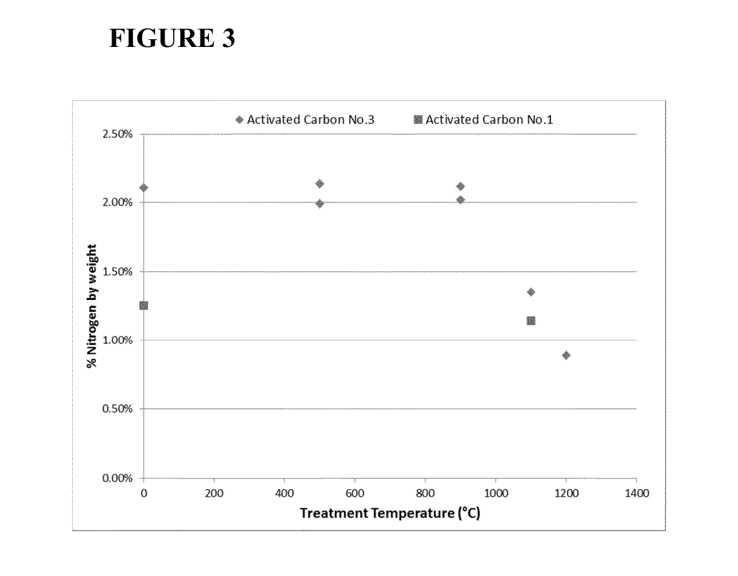

FIG. 3 is a comparison of the effects on nitrogen content (% by weight) after heat treatment (calcination) of two catalytic activated carbons: “AC No. 3” (an exemplary catalytic activated carbon as described herein), and “AC No. 1,” a commercially available catalytic activated carbon (Calgon Carbon, Pittsburgh, Pa.). The materials were analyzed by examination of N1s peaks from XPS spectra as described above. The data indicate that the nitrogen content of both catalytic activated carbons is reduced after heat treatment above about 900° C. This is also reflected by the data in Table 1 (compare No. 1 and No. 1 treated versus No. 3 and No. 3 treated).

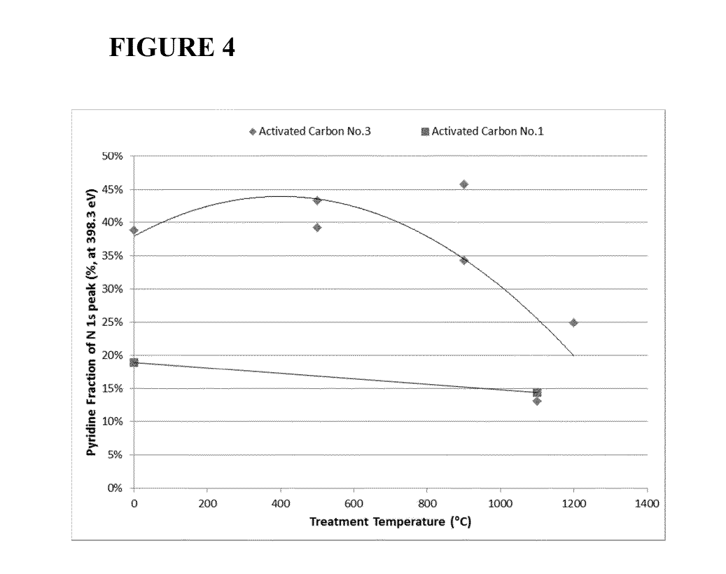

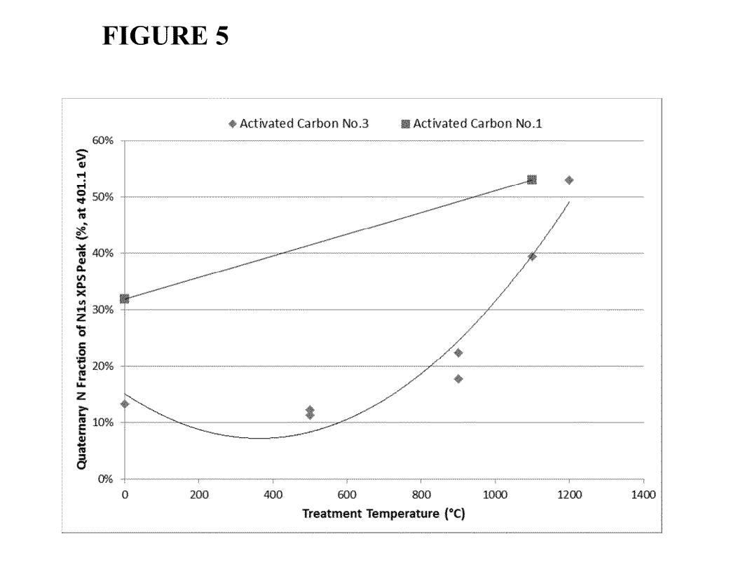

FIG. 4 is a comparison of the effects on the pyridine nitrogen fraction of the two catalytic activated carbons (AC No. 3 and AC No. 1) after heat treatment as determined by analysis of N1s peaks from XPS spectra. FIG. 5 is a comparison of the effects on the quaternary nitrogen fraction of two catalytic activated carbons (AC No. 3 and AC No. 1) after heat treatment as determined by analysis of N1s peaks from XPS spectra. FIGS. 4 and 5 demonstrate that calcination or heating the catalytic activated carbons modify or shift the amount of nitrogen species. In particular, the amount of pyridine and pyrrole content drops while the amount of quaternary amine species (See “c” in Table 1) is increased with heat treatment.

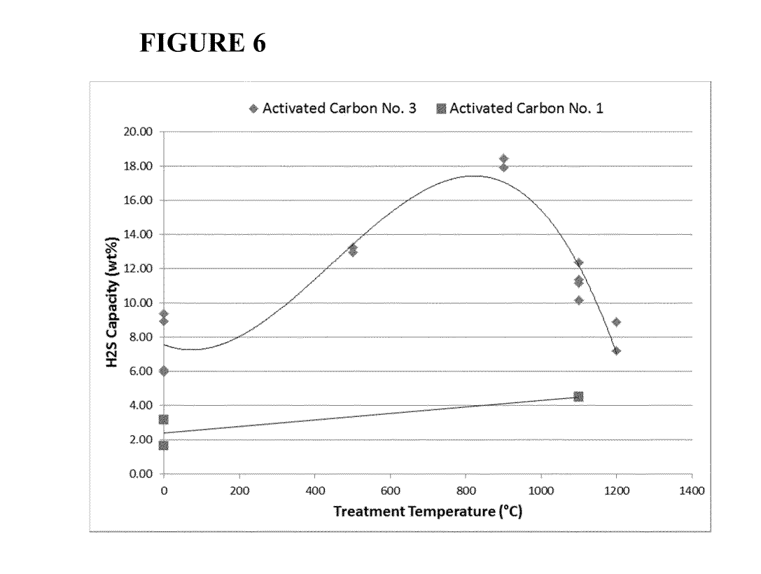

FIG. 6 is a comparison of the ASTM H₂S binding performance (H₂S adsorption capacity; % by weight) of two catalytic activated carbons (AC No. 3 and AC No. 1) after heat treatment. In this example, the materials were 30% by weight carbon, and 20% cuprous oxide. These data indicate that the ASTM capacity is enhanced upon heating with a peak for MWV carbon at about 800° C.

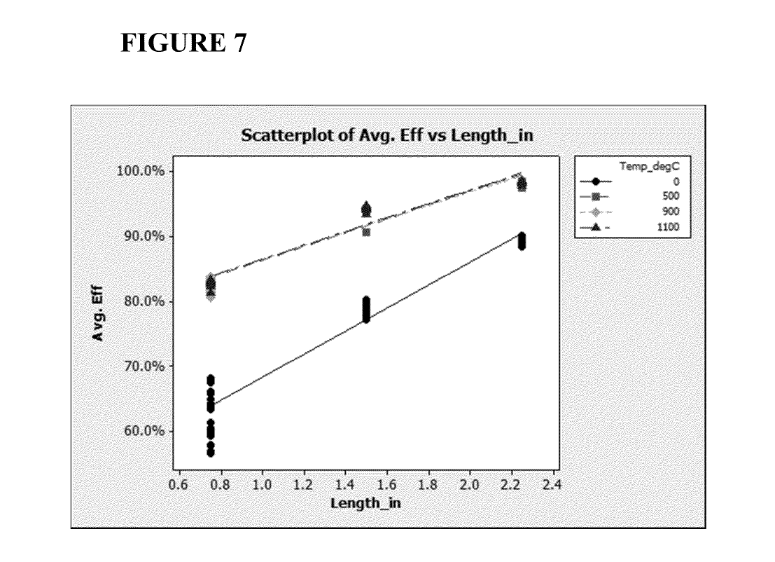

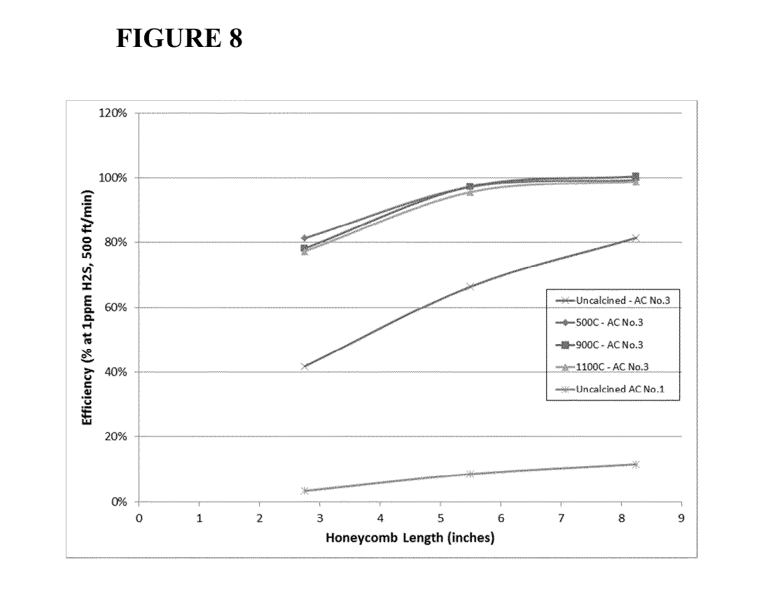

FIGS. 7 and 8 are comparisons of the efficiency versus length at 150 ft/min and 500 ft/min linear air velocity, respectively, with 1 ppm H₂S for the MWV carbon after heat treatment. Thus, heat treatment above 500° C. impacts the efficiency. The Calgon material lags behind the exemplary material described herein. 900° C. appears to be optimal for ASTM capacity but heat treatment above 500° C. improves all.

Preparation of Catalytic Activated Carbon Honeycomb Material

Various activated carbon honeycomb materials were prepared by mixing the activated carbon absorbent (i.e., activated carbon No. 1, activated carbon No. 2, or activated carbon No. 3) with a binder comprised of ball clay, sodium silicate and kaolin, and Cu₂O (if any) at the selected amounts as shown in TABLE 2, then extruding the mixture into a honeycomb structure having about 1.6 inches in diameter and about 5.75 inches in length. The activated carbon honeycomb materials of two cell densities were prepared and tested: 200 cspi and 150 cspi.

Furthermore, the activated carbon honeycomb materials tested were calcined activated carbon honeycombs and uncalcined activated carbon honeycombs.

Additionally, cuprous oxides of two particle size were used for the preparation of the activated carbon honeycomb: D90 particle size of 18 microns, and D90 particle size of less than 5 microns (i.e., ultrafine Cu₂O).

Determination of Hydrogen Sulfide (H₂S) Adsorption Capacity of the Activated Carbon Honeycomb Materials

The capacity of the adsorbent for the removal of hydrogen sulfide from an air stream (i.e., H₂S capacity) was determined using the ASTM standard test method D 6646-03 (Determination Of The Accelerated Hydrogen Sulfide Breakthrough Capacity Of Granular And Pelletized Activated Carbon) that was modified for activated carbon honeycomb material.

An air stream containing 1% by volume hydrogen sulfide and 80% humidity and having a temperature of 25° C. was passed through a 5.75-inch media of the activated carbon honeycomb at a linear velocity of 9.4 ft/min, until the 50 ppm breakthrough of H₂S was observed. The H₂S adsorption capacity of the activated carbon honeycomb per unit weight at 99.5% removal efficiency (gram of H₂S per gram of activated carbon honeycomb) was then calculated using the following equation:

$${H}_{2} S Adsorption Capacity ( \% wt ) = \frac{( 1.52 \times {10}^{- 5} ) \times C \times F \times T}{Weight of Activated Carbon Honerycomb Material}$$

where

C=Concentration of H₂S in the air stream (% by volume),

F=Flow rate of the air stream (cm³/min), and

T=Time to reach 50 ppm breakthrough of H₂S (min).

Activated carbon honeycomb samples in TABLE 2 were tested for the H₂S adsorption capacity. As shown in TABLE 2, the catalytic activated carbon honeycomb materials of present disclosure (derived from the activated carbon No. 3) showed higher H₂S adsorption capacity than the activated carbon honeycomb samples derived from the activated carbon No. 1 or the activated carbon No. 2.

Effect of Nitrogen Species and Cuprous Oxide in the Activated Carbon Honeycomb Material on the H₂S Adsorption Capacity

Activated carbon honeycomb samples Nos. 17, 21, 6, 18, 13 and 4 of TABLE 2 were tested from H₂S adsorption capacities using the modified ASTM standard test method D 6646-03. The comparative H₂S adsorption capacities of the samples were as shown in TABLE 3.

For the activated carbon honeycomb samples containing no cuprous oxide, the honeycomb sample derived from the activated carbon No. 3 showed almost four times higher in H₂S adsorption capacity compared to the honeycomb samples derived from the activated carbon No. 1 or the activated carbon No. 2.

For the activated carbon honeycomb samples containing 20% weight of cuprous oxide, improvements in H₂S adsorption capacity were observed for the honeycomb samples derived from the activated carbon No. 1, the activated carbon No. 2, or the activated carbon No. 3. However, the activated carbon honeycomb sample containing the activated carbon No. 3 and cuprous oxide showed the highest H₂S adsorption capacity.

Thus, the activated carbon honeycomb sample containing the activated carbon No. 3 and cuprous oxide showed higher H₂S adsorption capacity, compared to the activated carbon honeycomb sample containing cuprous oxide and the activated carbon No. 1, or the activated carbon honeycomb sample containing cuprous oxide and the activated carbon No. 2.

TABLE 3

| | | Amount of | | H₂S |
|---|---|---|---|---|
| | | Activated | Amount of | Adsorption |
| Sample | | Carbon | Cu₂O | Capacity |
| No. | Activated Carbon | (% wt) | (% wt) | (wt %) |
| 17 | Activated Carbon No. 1 | 30% | 0 | 0.3 |
| 21 | Activated Carbon No. 2 | 30% | 0 | 0.2 |
| 6 | Activated Carbon No. 3 | 30% | 0 | 4.7 |
| | (Present Disclosure) | | | |
| 18 | Activated Carbon No. 1 | 30% | 20% | 4.5 |
| 13 | Activated Carbon No. 2 | 30% | 20% | 8.2 |
| 4 | Activated Carbon No. 3 | 30% | 20% | 10.3 |
| | (Present Disclosure) | | | |

Effect of the Amount of Activated Carbon in the Activated Carbon Honeycomb Material on the H₂S Adsorption Capacity

Activated carbon honeycomb samples Nos. 1, 3 and 9 of TABLE 2 having different amounts of the activated carbon No. 3 but same amount of Cu₂O (20% weight) were tested from H₂S adsorption capacities using the modified ASTM standard test method D 6646-03. The comparative H₂S adsorption capacities of the samples were as shown in TABLE 4.

TABLE 4 showed that the H₂S adsorption capacity of the activated carbon honeycomb samples having same amount of Cu₂O but different amounts of activated carbon No. 3. The H₂S adsorption capacity of the activated carbon honeycomb material increased as the amount of the activated carbon No. 3 was increased.

TABLE 4

| | | Amount of | | H₂S |
|---|---|---|---|---|
| | | Activated | Amount of | Adsorption |
| Sample | | Carbon | Cu₂O | Capacity |
| No. | Activated Carbon | (% wt) | (% wt) | (wt %) |
| 1 | Activated Carbon No. 3 | 15% | 10% | 3.5 |
| 3 | Activated Carbon No. 3 | 30% | 10% | 9.8 |
| 9 | Activated Carbon No. 3 | 45% | 10% | 13.6 |

Effect of the Amount of Cuprous Oxide in the Activated Carbon Honeycomb Material on the H₂S Adsorption Capacity

Activated carbon honeycomb samples Nos. 6, 3 and 4 of TABLE 2 having same amount of the activated carbon No. 3 (30%) but different amounts of Cu₂O were tested from H₂S adsorption capacities using the modified ASTM standard test method D 6646-03. The comparative H₂S adsorption capacities of the samples were as shown in TABLE 5.

TABLE 5 showed that the H₂S adsorption capacity of the activated carbon honeycomb samples having same amount of the activated carbon No. 3 but different amounts of Cu₂O. The H₂S adsorption capacity of the activated carbon honeycomb materials increased as the amount of Cu₂O was increased.

TABLE 5

| | | Amount of | | H₂S |
|---|---|---|---|---|
| | | Activated | Amount of | Adsorption |
| Sample | Activated Carbon | Carbon | Cu₂O | Capacity |
| No. | Type | (% wt) | (% wt) | (wt %) |
| 6 | Activated Carbon No. 3 | 30% | 0% | 4.7 |
| 3 | Activated Carbon No. 3 | 30% | 10% | 9.8 |
| 4 | Activated Carbon No. 3 | 30% | 20% | 10.3 |

While the present disclosure is susceptible to various modifications and alternative forms, specific embodiments have been shown by way of example in the drawings and have been described in detail herein. However, the present disclosure is not intended to be limited to the particular forms disclosed. Rather, the present disclosure is to cover all modifications, equivalents, and alternatives falling within the scope of the present disclosure as defined by the following appended claims and their legal equivalents.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

TABLE 2

| | | Amount of | | | | | |
|---|---|---|---|---|---|---|---|
| Sample | Activated Carbon | Activated Carbon | Amount of | | H₂S Adsorption Capacity | | |
| No. | Type | (% wt) | Cu₂O (% wt) | Calcination | (% wt) | (lb/ft³) | (mg/ml) |
| 1 | Activated Carbon No. 3 | 15% | 10% | Yes | 3.5 | 0.8 | 13 |
| 2 | Activated Carbon No. 3 | 15% | 30% | Yes | 2.3 | 0.6 | 9 |
| 3 | Activated Carbon No. 3 | 30% | 10% | Yes | 9.8 | 1.8 | 29 |
| 4 | Activated Carbon No. 3 | 30% | 20% | Yes | 10.3 | 2.0 | 31 |
| 5 | Activated Carbon No. 3 | 30% | 20% | Yes | 8.0 | 1.5 | 25 |
| | | | (ultrafine Cu₂O) | | | | |
| 6 | Activated Carbon No. 3 | 30% | 0% | Yes | 4.7 | 0.9 | 14 |
| 7 | Activated Carbon No. 3 | 40% | 15% | Yes | 8.8 | 1.5 | 24 |
| | | | (ultrafine Cu₂O) | | | | |
| 8 | Activated Carbon No. 3 | 40% | 15% | Yes | 9.2 | 1.6 | 25 |
| 9 | Activated Carbon No. 3 | 45% | 10% | Yes | 13.6 | 2.1 | 33 |
| 10 | Activated Carbon No. 3 | 45% | 30% | Yes | 14.1 | 2.2 | 36 |
| 11 | Activated Carbon No. 3 | 15% | 10% | No | 3.1 | 0.8 | 13 |
| 12 | Activated Carbon No. 3 | 30% | 20% | No | 5.6 | 1.3 | 20 |
| 13 | Activated Carbon No. 3 | 30% | 20% | No | 7.5 | 1.5 | 24 |
| | | | (ultrafine Cu₂O) | | | | |
| 14 | Activated Carbon No. 3 | 40% | 15% | No | 8.1 | 1.6 | 25 |
| 15 | Activated Carbon No. 3 | 45% | 10% | No | 7.9 | 1.4 | 22 |
| 16 | Activated Carbon No. 3 | 45% | 30% | No | 13.8 | 2.2 | 35 |
| 17 | Activated Carbon No. 1 | 30% | 0% | Yes | 0.3 | 0.1 | 1 |
| 18 | Activated Carbon No. 1 | 30% | 20% | Yes | 4.5 | 1.2 | 18 |
| 19 | Activated Carbon No. 1 | 30% | 0% | No | 1.0 | 0.3 | 4 |
| 20 | Activated Carbon No. 1 | 30% | 20% | No | 2.4 | 0.7 | 11 |
| 21 | Activated Carbon No. 2 | 30% | 0% | Yes | 0.2 | 0.0 | 1 |
| 22 | Activated Carbon No. 2 | 30% | 10% | Yes | 5.5 | 1.0 | 16 |
| 23 | Activated Carbon No. 2 | 30% | 20% | Yes | 8.2 | 1.5 | 24 |

| | | Amount of | Amount of | | | |
|---|---|---|---|---|---|---|
| | Activated Carbon | Activated Carbon | Cu₂O | H₂S Adsorption Capacity | | |
| Sample | Type | (% wt) | (% wt) | (% wt) | (lb/ft³) | (mg/ml) |
| 24 | Activated Carbon No. 3 | 15% | 30% | 1.3 | 0.6 | 9 |
| 25 | Activated Carbon No. 3 | 30% | 20% | 10.0 | 3.1 | 50 |
| | | | (ultrafine Cu₂O) | | | |
| 26 | Activated Carbon No. 3 | 40% | 15% | 3.2 | 0.8 | 12 |
| 27 | Activated Carbon No. 3 | 45% | 10% | 12.2 | 3.0 | 48 |
| 28 | Activated Carbon No. 3 | 45% | 30% | 13.1 | 3.2 | 51 |
| 29 | Activated Carbon No. 1 | 30% | 0% | 0.1 | 0.0 | 1 |
| 30 | Activated Carbon No. 1 | 30% | 20% | 0.8 | 0.3 | 5 |
| 31 | Activated Carbon No. 2 | 30% | 20% | 6.3 | 2.0 | 32 |

1. A catalytic activated carbon material comprising:
a matrix including nitrogen-enriched activated carbon, cuprous oxide, and a binder,
wherein the nitrogen-enriched activated carbon includes from about 0.5% to about 10% by weight of nitrogen based on total weight of the nitrogen-enriched activated carbon, at least about 30% by weight of the nitrogen are aromatic nitrogen species having a binding energy of at least 398.0 eV as determined by XPS, and
wherein the matrix material is formed into a three-dimensional structure.

2. The material of claim 1, wherein the material comprises the nitrogen-enriched activated carbon in an amount of from 10% to about 80% by weight based on total weight of the material.

3. The material of claim 1, wherein the material comprises the cuprous oxide in an amount of from 5% to about 50% by weight based on total weight of the material.

4. The material of claim 1, wherein the cuprous oxide has a D90 particle size of less than about 40 microns.

5. The material of claim 1, wherein the three-dimensional structure is a honeycomb having a cell density of from about 10 to about 1500 cells per square inch.

6. The material of claim 5, wherein the material has a B.E.T. surface area of from about 200 m²/g to about 3000 m²/g.

7. The material of claim 1, wherein at least about 50% by weight of the nitrogen are aromatic nitrogen species having a binding energy of from about 398.0 eV to about 403.1 eV as determined by XPS.

8. The material of claim 1, wherein the nitrogen-enriched activated carbon is formed from a carbon precursor comprising a member selected from the group consisting of wood, wood dust, wood flour, cotton linters, peat, coal, lignite, petroleum pitch, petroleum coke, coal tar pitch, carbohydrates, coconut, fruit pits, fruit stones, nut shells, nut pits, sawdust, palm, vegetables, synthetic polymer, natural polymer, lignocellulosic material, and combinations thereof.

9. The material of claim 1, wherein the binder comprises a member selected from the group consisting of ceramic, clay, cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof.

10. A catalytic activated carbon material prepared according to a process comprising:
(a) activating a carbon precursor or pyrolyzing an activated carbon while contacting the carbon material with at least ammonia to provide a nitrogen-enriched activated carbon;
(b) admixing the nitrogen-enriched activated carbon with cuprous oxide, and a binder; and
(c) forming a three-dimensional structure from the admixture of (b).

11. A method of preparing a catalytic activated carbon material comprising:
(a) activating a carbon precursor or pyrolyzing an activated carbon while contacting the carbon material with a nitrogen-containing compound to provide a nitrogen-enriched activated carbon, wherein the nitrogen-enriched activated carbon includes from about 0.5% to about 10% by weight of nitrogen based on total weight of the nitrogen-enriched activated carbon, wherein at least about 30% by weight of the nitrogen is aromatic nitrogen species having a binding energy of at least about 398.0 eV as determined by XPS;
(b) admixing the nitrogen-enriched activated carbon with cuprous oxide and a binder; and
(c) forming a honeycomb structure from the admixture of (b).

12. The method of claim 11, wherein a step of activating a carbon precursor by pyrolyzing is performed prior to contacting or exposing the activated carbon to the nitrogen-containing compound.

13. The method of claim 12, wherein the activated carbon is pyrolyzed at a temperature of at least about 700° C. in the presence of the nitrogen-containing compound to provide a nitrogen-enriched activated carbon.

14. The method of claim 11, wherein the nitrogen-containing compound is ammonia.

15. The method of claim 11, wherein the step of activating a carbon precursor includes pyrolizing the carbon precursor while contacting the carbon material with a gas stream comprising ammonia and an oxygen-containing gas.

16. The method of claim 15, wherein the carbon precursor is pyrolyzed at a temperature of from about 800° C. to about 1200° C. while contacting the carbon material with an oxygen-containing gas and ammonia gas at a ratio of up to 90:10 for a period sufficient to remove surface oxides from the carbon precursor.

17. The method of claim 11, wherein the step of activating a carbon precursor includes pyrolizing the carbon precursor at a temperature of above 700° C. while contacting the carbon material with a gas stream comprising ammonia.

18. A method of removing sulfide-containing compounds from a fluid stream, the method comprising contacting the catalytic activated carbon material of claim 1 with a fluid stream comprising sulfide-containing compounds.

19. The method of claim 18, wherein the fluid stream is a gas stream, liquid stream or both comprising a sulfide-containing compound.

20. The method of claim 19, wherein the sulfide-containing compound comprises hydrogen sulfide.

21. A calcined catalytic activated carbon material comprising:
a matrix including nitrogen-enriched activated carbon, cuprous oxide, and a binder, wherein the nitrogen-enriched activated carbon includes from about 0.5% to about 10% by weight of nitrogen based on total weight of the nitrogen-enriched activated carbon,
wherein the matrix material is formed into a three-dimensional structure and calcined at from about 500° C. to about 1200° C., and wherein at least about 30% by weight of the nitrogen are aromatic nitrogen species having a binding energy of at least 401.3 eV as determined by XPS.

22. The material of claim 21, wherein the matrix material is formed into a honeycomb structure and calcined at a temperature of from about 500° C. to about 1100° C.

23. The material of claim 21, wherein the matrix material comprises the nitrogen-enriched activated carbon in an amount of from 10% to about 80% by weight based on total weight of the material.

24. The material of claim 21, wherein the matrix material comprises the cuprous oxide in an amount of from 5% to about 50% by weight based on total weight of the material.

25. The material of claim 21, wherein the cuprous oxide has a D90 particle size of less than about 40 microns.

26. The material of claim 22, wherein the honeycomb structure has a cell density of from about 10 to about 1500 cells per square inch.

27. The material of claim 26, wherein the material has a B.E.T. surface area of from about 200 m²/g to about 3000 m²/g.

28. The material of claim 21, wherein at least about 50% by weight of the nitrogen are aromatic nitrogen species having a binding energy of about 401.3 eV as determined by XPS.

29. The material of claim 21, wherein the binder comprises a member selected from the group consisting of ceramic, clay, cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof.

30. A calcined catalytic activated carbon material prepared according to a process comprising:
(a) activating a carbon precursor or pyrolyzing an activated carbon while contacting the carbon material with at least ammonia to provide a nitrogen-enriched activated carbon;
(b) admixing the nitrogen-enriched activated carbon with cuprous oxide, and a binder;
(c) forming a three-dimensional structure from the admixture of (b); and
(d) heating the structure from (c) at a temperature of from about 500° C. to about 1200° C., wherein the calcined catalytic activated carbon displays enhanced ASTM H₂S adsorption capacity.

31. A method of preparing a calcined catalytic activated carbon material comprising:
(a) activating a carbon precursor or pyrolyzing an activated carbon while contacting the carbon material with a nitrogen-containing compound to provide a nitrogen-enriched activated carbon, wherein the nitrogen-enriched activated carbon includes from about 0.5% to about 10% by weight of nitrogen based on total weight of the nitrogen-enriched activated carbon, wherein at least about 30% by weight of the nitrogen is aromatic nitrogen species having a binding energy of at least about 398.0 eV as determined by XPS;
(b) admixing the nitrogen-enriched activated carbon with cuprous oxide and a binder;
(c) forming a honeycomb structure from the admixture of (b); and
(d) heating the structure from (c) sufficiently to increase the aromatic nitrogen species having a binding energy of at least about 401.3 eV by at least 30% as determined by XPS.

32. The method of claim 31, wherein the step of activating a carbon precursor includes pyrolyzing the carbon precursor at a temperature of at least about 700° C. in the presence of the nitrogen-containing compound to provide a nitrogen-enriched activated carbon.

33. The method of claim 31, wherein the nitrogen-containing compound is ammonia.

34. The method of claim 32, wherein the step of activating a carbon precursor or pyrolyzing an activated carbon includes contacting the carbon with a gas stream comprising ammonia and an oxygen-containing gas through or over the carbon precursor.

35. The method of claim 34, wherein the carbon precursor or activated carbon is pyrolyzed at a temperature of from about 800° C. to about 1200° C. while contacting the carbon with a gas stream of an oxygen-containing gas and ammonia gas at a ratio of up to 90:10 for a period sufficient to remove surface oxides from the carbon precursor.

36. The method of claim 31, wherein the step of activating a carbon precursor or pyrolyzing an activated carbon includes pyrolizing the carbon at a temperature of above 700° C. while contacting the carbon with a gas stream comprising ammonia.

37. A method of removing sulfide-containing compounds from a fluid stream, the method comprising contacting the catalytic activated carbon honeycomb material of claim 22 with a fluid stream comprising sulfide-containing compounds.

38. The method of claim 37, wherein the fluid stream is a gas stream, liquid stream or both comprising a sulfide-containing compound.

39. The method of claim 38, wherein the sulfide-containing compound comprises hydrogen sulfide.
